(19) United States
(12) Patent Application Publication
(10) Pub. No.: US 2016/0363061 A1
(43) Pub. Date: Dec. 15, 2016

(54) Control Systems and Methods for Reducing Vibration in Internal Combustion Engines

(71) Applicant: BRUNSWICK CORPORATION, Lake Forest, IL (US)

(72) Inventors: Andrew S. Waisanen, Fond du Lac, WI (US); Michael A. Purdy, Oshkosh, WI (US); Jeffrey J. Broman, Slinger, WI (US)

(73) Assignee: BRUNSWICK CORPORATION, Lake Forest, IL (US)

(21) Appl. No.: 14/489,075

(22) Filed: Sep. 17, 2014

(51) Int. Cl. F02D 31/00; F02B 75/00

(52) U.S. Cl. CPC F02D 31/001; F02B 75/00

(57) ABSTRACT

Systems and methods are for controlling internal combustion engines having a plurality of piston-cylinders that cause rotation of a crankshaft. A crankshaft sensor is configured to sense rotational speed of the crankshaft. A controller is configured to calculate an acceleration for each piston-cylinder based upon the rotational speed of the crankshaft and then balance the accelerations of the respective piston-cylinders by modifying a combustion input to one or more of the piston-cylinders in order to reduce engine vibration.

### FIELD

The present disclosure relates to internal combustion engines and to control systems and methods for reducing vibrations in internal combustion engines, such as engines for propelling marine vessels.

### BACKGROUND

U.S. Pat. No. 6,109,986 discloses an idle speed control system for a marine propulsion system. The system controls an amount of fuel injected into the combustion chamber of an engine cylinder as a function of the error between a selected target speed and an actual speed. The speed can be engine speed measured in revolutions per minute or, alternatively, it can be boat speed measured in nautical miles per hour or kilometers per hour. By comparing target speed to actual speed, the control system selects an appropriate pulse width length for the injection of fuel into the combustion chamber and regulates the speed by increasing or decreasing the pulse width.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples systems comprise an internal combustion engine having a plurality of piston-cylinders that cause rotation of a crankshaft, a crankshaft sensor configured to sense rotational speed of the crankshaft, and a controller having a processor and a memory. The controller is configured to calculate an acceleration of each piston-cylinder based upon the rotational speed of the crankshaft and then balance the accelerations of the respective piston-cylinders by modifying a combustion input to one or more of the piston-cylinders.

In certain examples, methods are for controlling an internal combustion engine having a plurality of piston-cylinders that cause rotation of a crankshaft. The methods comprise sensing rotational speed of the crankshaft, calculating an acceleration of each piston-cylinder based upon the rotational speed of the crankshaft, and then balancing the accelerations of the respective piston-cylinders by modifying a combustion input to one or more of the piston-cylinders.

### BRIEF DESCRIPTION OF THE DRAWINGS

Examples are described with reference to the following figures. The same numbers are used throughout the figures to reference like features and like components.

FIG. 1 is a schematic of a system according to the present disclosure.

FIG. 2 is a graph depicting cylinder pressure in a plurality of piston-cylinders of an internal combustion engine during one combustion cycle.

FIG. 3 is a graph depicting angular acceleration of a crankshaft of the internal combustion engine during one combustion cycle.

FIG. 4 is a graph depicting magnitude of the piston-cylinder components of the angular acceleration of the crankshaft over a plurality of combustion cycles.

FIG. 5 is a flow chart depicting one example of a method according, to the present disclosure.

FIG. 6 is a flow chart depicting another example of a method according to the present disclosure.

### DETAILED DESCRIPTION OF THE DRAWINGS

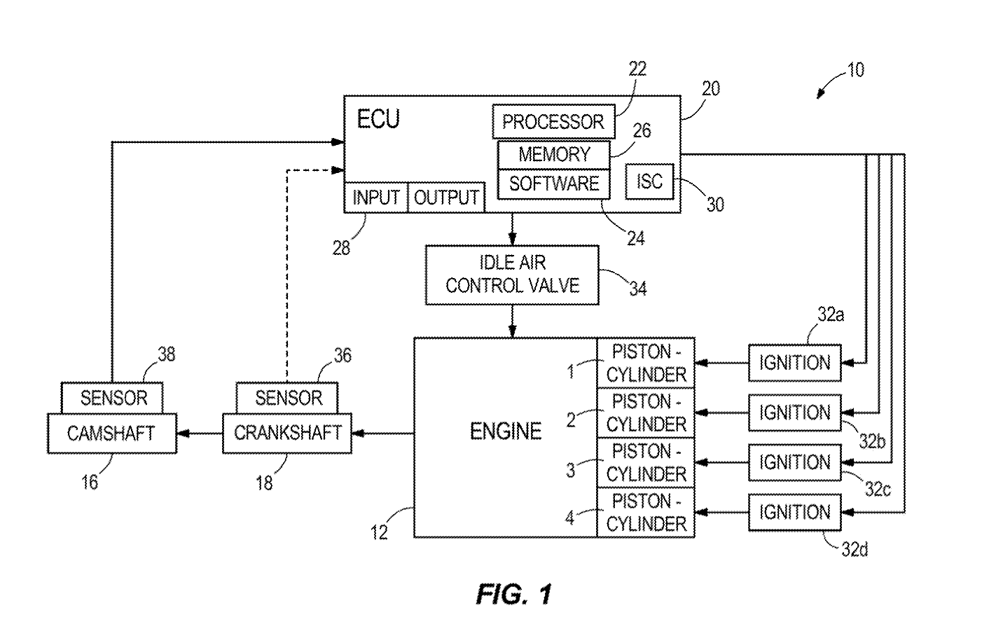

FIG. 1 is a schematic showing a non-limiting example of a system 10 for controlling operations of an internal combustion engine 12. In this particular example, the engine 12 is a four-stroke engine having, four piston-cylinders 1-4 that are arranged in an inline formation. However the type of stroke and number of piston-cylinders can vary from that which is shown. The arrangement of the piston-cylinders also can vary and in some examples can be arranged in a V-configuration or opposed-configuration instead of an inline configuration. As is conventional, reciprocation of the pistons in the cylinders causes rotation of a crankshaft 18, which in turn causes rotation of a camshaft 16. In situations where the engine 12 is configured for use in marine applications, rotation of the crankshaft 18 and camshaft 16 causes rotation of one or more propulsors (e.g. propellers, impellers, and/or the like) for causing movement of a marine vessel. Such arrangements are known in the art and examples are disclosed in U.S. Pat. Nos. 7,806,741; 7,354,324; 7,299,783; 6,571,753; 6,295,963; 6,109,986; and 5,950,588, which are incorporated herein by reference.

The system 10 includes an Engine Control Unit (ECU) 20 for controlling operations of the engine 12. The ECU 20 is a programmable controller that includes a computer processor 22, software 24, memory (i.e. computer storage) 26 and an input/output (interface) device 28. The processor 22 loads and executes the software 24 from the memory 26. When executed, software 24 controls the engine 12 to operate according to the functionality described in further detail below. In some examples, the processor 22 can comprise a microprocessor and related circuitry that retrieves and executes software 24 from memory 26. Processor 22 can be implemented within a single device but can alternately be distributed across multiple processing devices or sub-systems that cooperate in executing program instructions. Examples include general purpose central processing units, application specific processors, and logic, devices, as well as any other type of processing device, combinations of processing devices, and/or variations thereof. Additional examples of suitable processors are disclosed in U.S. Pat. No. 7941,253 and 6,273,771 which are incorporated herein by reference.

The ECU 20 includes an idle speed controller (ISC) 30, which can be a sub-system of the ECU 20 or a separate controller, distinct from the processor 22, software 24, memory 26 and input/output device 28 of the ECU 20. For discussion purposes herein below, the ISC 30 is a sub-system of the ECU 20; however it should be recognized that this is a non-limiting example and the particular configurations of the ECU 20 and ISC 30 can vary from that which is shown and described. The ISC 30 is configured to maintain the engine 12 at a certain idle speed, which in this disclosure is referred to as an “idle speed set point”. The idle speed set point can be a calibrated engine speed value that typically is selected by the manufacturer through trial and error so as to avoid stalling of the engine 12 when it is operated at idle speed and when it is shifted into forward or reverse gear. Other methods of selecting the idle speed set point are known in the art. The ISC 30 is configured to control one or more “combustion inputs” to the piston-cylinders 1-4 to thereby maintain the speed of the engine 12 at the noted idle speed set point. Examples of “combustion inputs” can include timing of ignition (i.e. spark provided by spark plugs 32a-32d), quantity and/or rate of fuel provided to the engine, spark energy, spark duration, injection timing, quantity and/or rate of airflow provided to the engine 12 via an idle air control valve 34, and/or the like. In certain examples, the idle air control valve 34 can be an electronic valve located downstream of a main throttle body for the engine 12. The idle air control valve 34 typically is located in the intake air plenum for the engine 12. In certain examples, the ISC 30 can be a proportional integral derivative controller (PID), which calculates and monitors the rate of change of speed of rotation of the crankshaft 18 and how long the rate of change occurs. The ISC 30 is configured to compare the results of this calculation to one or more thresholds stored in the memory 26, and then modify the one or more of the noted combustion inputs accordingly to thereby maintain the engine 12 at the idle speed setpoint. It will be recognized by one having ordinary skill in the art that the type of ISC 30 can also vary from that which is shown and described. In another example, idle airflow to the engine may be controlled by the ECU via an electronically driven throttle. In this case, a separate idle air control valve is not needed.

The system 10 also includes a crankshaft sensor 36 that is configured to sense rotation and position of the crankshaft 18 and then provide electronic signals to the ECU 20 that represent the speed of rotation of the crankshaft 18 and the rotational position of the crankshaft 18. Optionally, as described further herein below, the system 10 also includes a camshaft sensor 38 that is configured to sense rotation and position of the camshaft 16 and then provide electronic signals to the ECU 20 that represent the speed of rotation of the camshaft 16 and the rotational position of the camshaft 16. In certain examples, the camshaft sensor 38 and/or crankshaft sensor 36 can be conventional encoders that are respectively located on the camshaft 16 and the crankshaft 18; however any conventional sensor that is configurable to sense speed of rotation and communicate this information to the ECU can be utilized.

Based upon the signals provided by the crankshaft sensor 36, the ISC 30 is configured to compare the actual idle speed of the engine 12 to the idle speed setpoint, which is stored in the memory 26. When the actual speed of the engine 12 deviates from the idle speed set point, the ISC 30 is configured to modify one or more of the noted combustion inputs to the piston-cylinders 1-4 to thereby maintain the engine 12 at the idle speed setpoint and/or respond to a need for a change in torque output of the engine 12. For example, the ISC 30 can be configured to change the rate or amount of airflow to the engine 12 by operating the idle air control valve 34. If a quicker response is necessary, the ISC 30 can be configured to control the timing of ignition via the spark plugs 32a-32d.

The above-described control systems and methods for controlling engine idle speed are implemented over relatively long periods of time (e.g. seconds) and are applied globally to the engine 12, that is, the above-mentioned systems and methods equally affect all of the piston-cylinders 1-4 of the engine 12. Through research and experimentation the present inventors have recognized that it is desirable to provide improved systems and methods that control the engine 12 on a piston-cylinder-to-piston-cylinder basis, to thereby reduce inequality of output amongst the piston-cylinders 1-4. The inventors have further realized that by reducing inequality of output amongst the piston-cylinders 1-4, it is possible to reduce unwanted vibration of the engine 12.

According to the present disclosure, the ECU 20 is uniquely configured to calculate an acceleration of each individual piston-cylinder 1-4 based upon the rotational speed of the crankshaft 18, and thereafter balance the accelerations of the respective piston-cylinders 1-4 by modifying one of the noted combustion inputs to one or more of the plurality of piston-cylinders. As explained further herein below, the ECU 20 is uniquely configured to calculate the acceleration of each piston-cylinder 1-4 during each of a plurality of combustion cycles N, each combustion cycle N consisting of one combustion event per piston-cylinder 1-4. The ECU 20 is further configured to store the acceleration of each piston-cylinder 1-4 during each of the combustion cycles in a buffer, and thereafter perform a statistical analysis on the buffer to identify any accelerations that are out of balance.

As discussed above, the crankshaft sensor 36 senses the speed of rotation of the crankshaft 18 and provides this information to the ECU 20. The ECU 20 can also be configured to differentiate this information and optionally to filter this information to thereby obtain filtered angular acceleration of the crankshaft 18 associated with each respective combustion event for each piston-cylinder. In certain examples, the filtering, step can include filtering the information with a low-pass filter so as to remove inconsistencies caused by components of the system 10 such mechanical effects of the camshaft or other causes of inconsistencies.

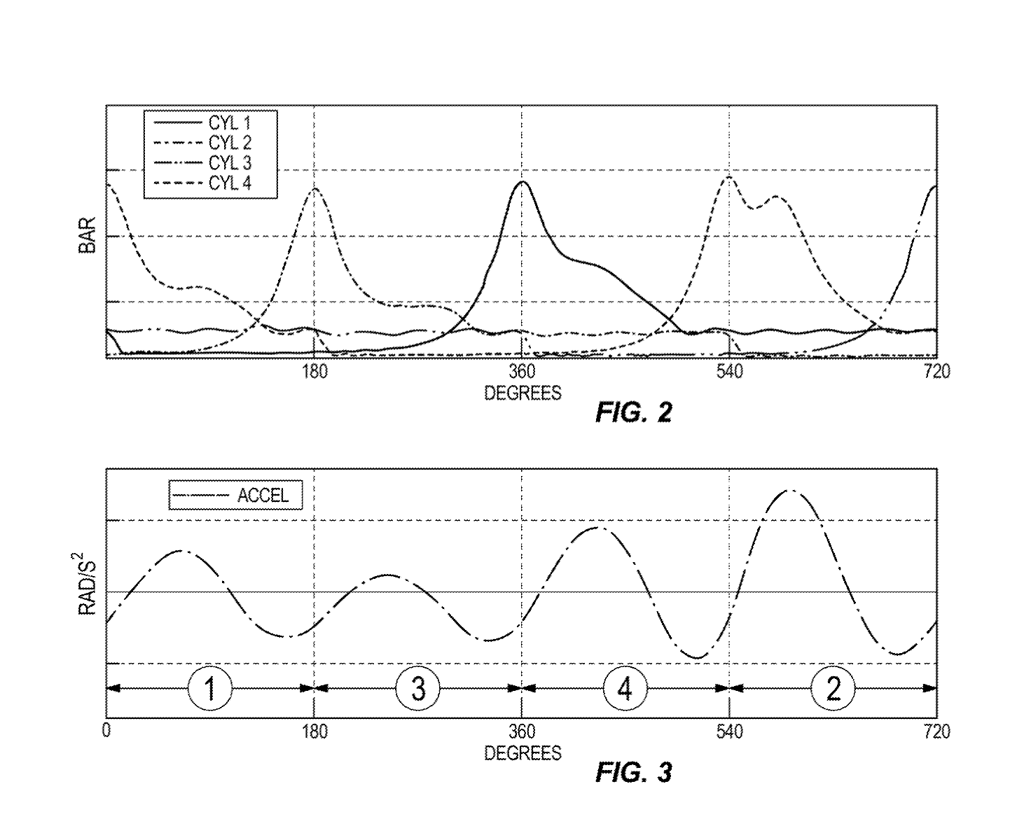

FIG. 2 is a graph depicting exemplary cylinder pressure changes in the four piston-cylinders 1-4 during one combustion cycle that includes four combustion events (i.e. one combustion event in each cylinder) which together cause two revolutions of the crankshaft 18. The data provided in FIG. 2 can be obtained by, for example, cylinder pressure sensors connected to each individual piston-cylinder. For comparison, FIG. 3 is a graph depicting filtered angular acceleration of the crankshaft 18, as calculated by the presently disclosed ECU 20. As shown by comparison of FIG. 2 and FIG. 3, the angular acceleration of the crankshaft 18 slows down during compression. Then, dependent on the energy achieved during the combustion event in the particular piston-cylinder 1-4, the angular acceleration increases. Thus by calculating (and optionally filtering) angular acceleration, as discussed herein above, the ECU 20 is able to accurately define the positive and negative acceleration of each piston in each piston-cylinder 1-4, as shown in FIG. 3.

Once the acceleration is calculated for each individual piston-cylinder 1-4, the ECU 20 is configured to calculate the strength of combustion of each piston-cylinder 1-4 during each combustion event, i.e. how much work each piston-cylinder 1-4 is doing during each combustion event. In certain examples, the strength of combustion of each piston-cylinder 1-4 can be calculated by obtaining the root mean square magnitude of acceleration during each combustion event. Other methods of calculating the strength of combustion could be used instead. The root mean square calculation can be performed as follows:

$${α}_{RMS} = \sqrt{\frac{1}{n} {\sum }_{i = 1}^{n} {( {α}_{i} - \overline{α} )}^{2}}$$

where:
n is the number of samples in the power stroke for cylinder m
aᵢ is the instantaneous crankshaft acceleration at crankshaft angle i,
and α̅ is the average crankshaft acceleration over the power stroke period

The ECU 20 can further be configured to store this value in a buffer until values for a predetermined number N of combustion cycles are stored in the buffer. The number N is a preselected value that is stored in the memory 26 and can vary depending upon the desired responsiveness of the system 10. An example of a buffer for the data shown in FIG. 2, where the number N=25 is shown herein below:

TABLE 1
25 Cycle Buffer (N = 25) for a 4-cylinder 4-stroke engine
Buffer

| Cylinder | | Cyl-1 | Cyl-3 | Cyl-4 | Cyl-2 |
|---|---|---|---|---|---|
| Crank Angle° | | 0-180 | 180-360 | 360-540 | 540-720 |
| Cycle (#) | 1 | 193 | 213 | 132 | 191 |
| | 2 | 207 | 252 | 124 | 139 |
| | 3 | 170 | 236 | 139 | 161 |
| | 4 | 247 | 217 | 116 | 162 |
| | 5 | 172 | 225 | 101 | 157 |
| | 6 | 244 | 295 | 138 | 156 |
| | 7 | 164 | 184 | 138 | 218 |
| | 8 | 235 | 260 | 130 | 135 |
| | 9 | 165 | 232 | 143 | 181 |
| | 10 | 218 | 222 | 121 | 128 |
| | 11 | 222 | 236 | 130 | 134 |
| | 12 | 184 | 229 | 164 | 150 |
| | 13 | 218 | 242 | 138 | 153 |
| | 14 | 200 | 243 | 148 | 122 |
| | 15 | 205 | 201 | 179 | 177 |
| | 16 | 156 | 200 | 167 | 169 |
| | 17 | 201 | 201 | 161 | 153 |
| | 18 | 195 | 254 | 185 | 174 |
| | 19 | 169 | 181 | 105 | 156 |
| | 20 | 237 | 298 | 124 | 131 |
| | 21 | 179 | 255 | 204 | 178 |
| | 22 | 183 | 208 | 103 | 173 |
| | 23 | 205 | 229 | 141 | 149 |
| | 24 | 165 | 282 | 196 | 133 |
| | 25 | 163 | 241 | 190 | 150 |

| | | | | |
|---|---|---|---|---|
| Avg | 196 | 233 | 145 | 157 |
| SD (σ) | 40 | | | |

Thereafter, the ECU 20 can further be configured to conduct a statistical analysis of the values in the buffer to determine whether the values for each piston-cylinder 1-4 are within a stored threshold amount of the remaining piston-cylinders 1-4. The stored threshold amount is a preselected value that can be calibrated by the manufacturer and stored in the memory 26. Based upon this statistical analysis the ECU 20 is able to identify whether the piston-cylinders 1-4 are respectively performing an equal amount of work over the course of the N combustion cycles.

The type of statistical analysis can vary. Sin certain examples, the ECU 20 is configured to calculate the standard deviation of the average angular acceleration values of each piston-cylinder 1-4. Thereafter, if the ECU 20 determines that the statistical average is outside of the threshold amount, the ECU 20 is configured to modify a combustion input to the particular piston-cylinder that is providing values that are outside of the threshold amount. For example, the ECU 20 can be configured to cause an advance or retardation of timing of ignition (spark) in the particular piston-cylinder that is providing the values that are outside of the threshold amount. In certain examples, the amount of change necessary to balance the work performed by the respective piston-cylinders 1-4 can be determined by the ECU 20 via a look-up table. Thus the ECU 20 is configured to modify the combustion input(s) to cause the accelerations associated with the individual piston-cylinders 1-4 to converge upon a nominal value. The ECU 20 can also be configured to maintain the same average so as to maintain the RPM (as described herein above), and at the same time obtain the same acceleration caused by each piston-cylinder 1-4.

For example: Assume an arbitrary SD (σ) threshold of 30. Since σ=40 exceeds the defined threshold, piston-cylinder calibration offsets are iteratively applied until σ<30 is satisfied. For example, timing of ignition (spark) could be incrementally advanced for piston-cylinders 4-2 and retarded for 1-3 until σ<30 is satisfied.

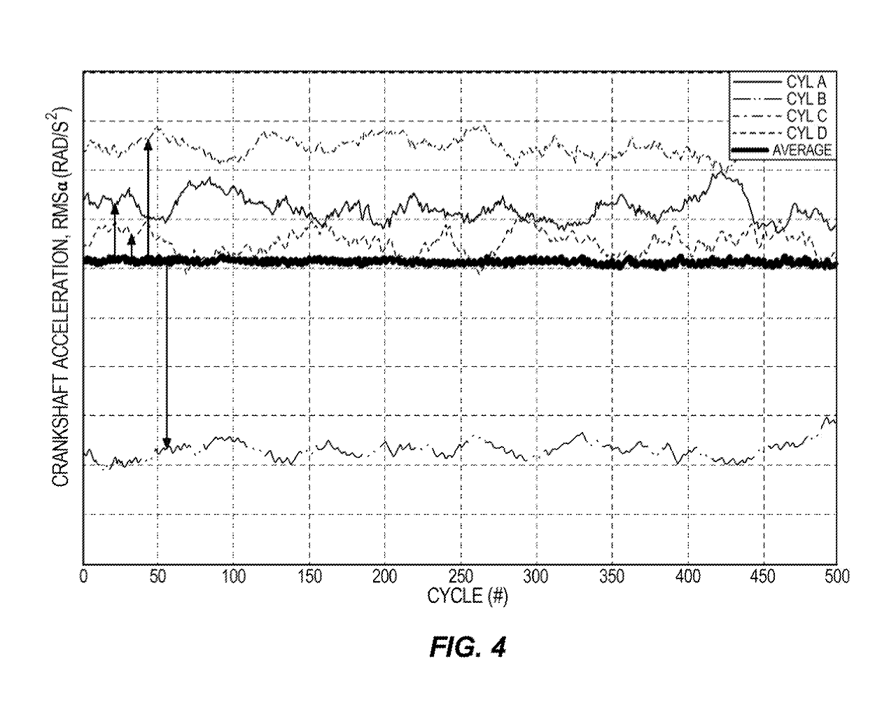

For further illustration. FIG. 4 shows crankshaft acceleration for piston-cylinders 1-4 over a plurality of combustion cycles, each cycle including one combustion event per piston-cylinder. The nominal average value is also shown. As shown in FIG. 4, the average angular acceleration from piston-cylinder-to-piston-cylinder is quite different. Therefore, even though the ISC 30 is maintaining the speed of the engine 12 by adjusting airflow and timing of ignition, there still is uneven combustion amongst the respective piston-cylinders 1-4 because the piston-cylinder 1 is producing significantly less torque than the remaining piston-cylinders. The present inventors have identified this as a problem and have endeavored to provide the presently disclosed systems and methods, which balance the angular acceleration output amongst the individual respective piston-cylinders 1-4 and yet still maintain the idle speed setpoint of the engine.

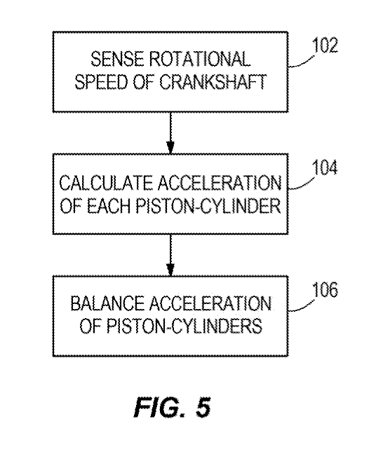

FIG. 5 depicts one example of a method according to the present disclosure. At step 102, rotational speed of the crankshaft 18 is sensed by the crankshaft sensor 36 and communicated to the ECU 20. At step 104, the ECU 20 calculates an acceleration of each piston-cylinder 1-4 based upon the rotational speed of the crankshaft 18, as described herein above. At step 106, the ECU 20 balances the acceleration of the respective piston-cylinders 1-4 by modifying a combustion input to one or more of the piston-cylinders 1-4.

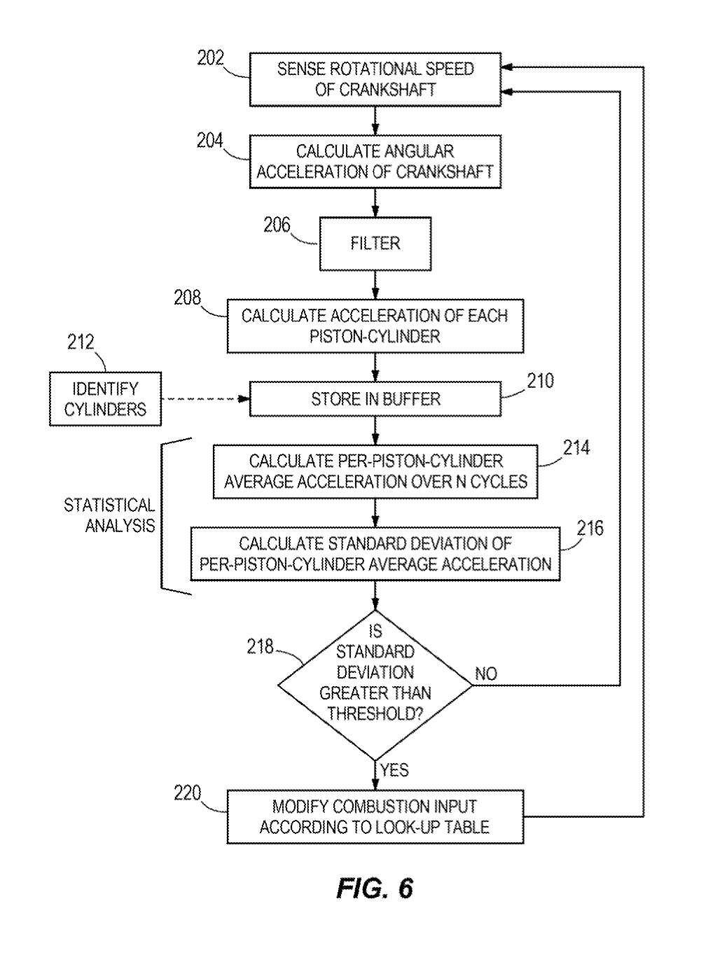

FIG. 6 depicts another example of a method according to the present disclosure. At step 202, the rotational speed of the crankshaft 18 is sensed by the crankshaft sensor 36 and communicated to the ECU 20. At step 204, the ECU 20 calculates angular acceleration of the crankshaft 18 by differentiating the rotational speed of the crankshaft 18. At step 206, the ECU 20 filters the angular acceleration of the crankshaft 18 through a low pass filter to thereby remove artifacts that are not derived from combustion. At step 208, the ECU 20 calculates the acceleration of each piston-cylinder 1-4 based upon the rotational speed of the crankshaft 18. As discussed herein above, the ECU 20 calculates the acceleration of each piston-cylinder 1-4 during each of a plurality of combustion cycles, each combustion cycle consisting of one combustion event per piston-cylinder. Effectively, the ECU 20 quantifies the acceleration of each piston-cylinder 1-4 based upon the angular acceleration of the crankshaft 18 that is caused by each piston-cylinder 1-4. In certain non-limiting examples, the acceleration of each piston-cylinder 1-4 can be quantified by calculating a root mean square of the portion of the angular acceleration of the crankshaft 18 that is caused by each piston-cylinder 1-4.

At step 210, the ECU 20 stores the acceleration of each piston-cylinder 1-4 during each of the combustion cycles in a buffer. An example is shown herein above in Table 1. At steps 214 and 216, the ECU 20 performs a statistical analysis on the buffer to identify any accelerations that are out of balance. In a non-limiting example, the statistical analysis can include calculating the per-piston-cylinder average acceleration over N cycles (at step 214) and calculating the standard deviation of the per-piston-cylinder average acceleration (at step 216). At step 218, the ECU 20 compares the result of the statistical analysis to a threshold stored in the memory of the ECU 20 to identify the accelerations that are out of balance. If the standard deviation is less than the threshold, the method returns to step 202. If the standard deviation is greater than the threshold, at step 220, the ECU 20 modifies one or more of the noted combustion inputs according to a look-up table stored in the memory of the ECU 20 to thereby balance the accelerations of the respective piston-cylinders 1-4. Thereafter the method returns to step 202.

In examples of the presently disclosed systems that include the camshaft sensor 38, optionally at step 212, the ECU 20 can be configured to identify the particular piston-cylinder 1-4 that requires corrective action in the form of modified combustion input(s). For example, it is known that the crankshaft 18 rotates twice per combustion event in the engine 12 and the camshaft 16 rotates only once per combustion event. The firing order of the piston-cylinders 1-4 is also a known value. In the example of FIG. 1, which has four piston-cylinders 1-4, this basis can allow the ECU 20 to be configured to distinguish between piston-cylinder 1 and piston-cylinder 4, for example where both pistons 1 and 4 reach top-dead center at the same time. The ECU 20 can be programmed to compare the position of the crankshaft 18 and the camshaft 16 to thereby identify which one is on the top-dead-center power stroke and which is on the top-dead-center exhaust stroke. With this knowledge, the ECU 20 can then modify the combustion inputs to the correct piston-cylinder 1-4.

In examples that do not include the camshaft sensor 38, the ECU 20 can be programmed with the tiring order and the position of the crankshaft 18, but it will not know which piston-cylinder is which. In these examples, the ECU 20 can be programmed to run a diagnostic. More specifically, the ECU 20 can be programmed to assign each piston-cylinder 1-4 a gated window during its power stroke between 0-720 degrees that is sensed by the crankshaft sensor 36 and communicated to the ECU 20. The ECU 20 can store the accelerations in a table that generally identifies each piston-cylinder based upon the gated angle domain window in which they produce values. The ECU 20 can be programmed to modify combustion inputs based upon the unique gated angle domain window rather than a specific piston-cylinder assignment. In other words, the combustion inputs are modified for the targeted piston-cylinder without needing to identify its correct physical location in the software.

An example is provided herein below:

### Problem:

A four-stroke, inline, four-cylinder engine 12 having a 1-3-4-2 firing order needs to advance spark on “piston-cylinder 1” to improve engine vibration. A cam position sensor 38 isn't available to identify in the ECU 20 which piston-cylinder is 1. However, the ECU 20 is programmed to detect top-dead-center during start-up, start a counter from 0-720° and assume 0° is top-dead-center of the power-stroke on piston-cylinder 1. Thus, any change in timing of ignition applied to piston-cylinder 1 in the ECU 20 affects combustion around the 0-180° gate of the encoder signal.

### Scenario #1

The engine 12 starts up, top-dead-center is detected, and the 0-720° counter starts in the ECU 20. By chance, the 0° location correctly corresponds with the power-stroke on piston-cylinder 1, so changes made to piston-cylinder 1 in the timing of ignition table would correctly affect piston-cylinder 1. The strategy identifies an advancement in timing of ignition is required in the gated window between 0-180°. Because the ECU 20 identifies piston-cylinder 1 with the 0-180° window of the crankshaft position, it applies the advancement to piston-cylinder 1 in the ECU 20, and the vibration of the engine 12 is improved.
Firing Order: 1-3-4-2
Window Gates: [0-180]-[180-360]-[360-540]-[540-720]
Software Cylinder ID: 1-3-4-2

### Scenario #2

The engine 12 starts up, TDC is detected, and the 0-720° counter starts in the ECU 20. This time, the 0° location from the software's perspective corresponds with the physical power stroke on piston-cylinder 4. Since the software 24 associates the 0-180′ gated window with piston-cylinder 4, changes made to piston-cylinder 1 in the timing of ignition table would actually affect piston-cylinder 4, which is undesirable. However, the control strategy calls for an advancement in timing of ignition on the piston-cylinder in the 360-540° gated window because this is the combustion event that is measuring “weak”. On the software side, this gated window is associated with piston-cylinder 4, so an advancement in timing of ignition (spark) is applied to piston-cylinder 4 in the software 24. However, the 360-540° gated window actually corresponds to piston-cylinder 1 in the physical world, so the vibration of the engine 12 is improved.
Firing Order: 4-2-1-3
Window Gates: [0-180]-[180-360]-[360-540]-[540]-720]
Software Cylinder ID: 1-3-4-2

In the above description, certain terms have been used for brevity, clarity, and understanding. No unnecessary limitations are to be inferred therefrom beyond the requirement of the prior art because such terms are used for descriptive purposes and are intended to be broadly construed. The different systems and method steps described herein may be used alone or in combination with other systems and methods. It is to be expected that various equivalents, alternatives and modifications are possible within the scope of the appended claims. Each limitation in the appended claims is intended to invoke interpretation under 35 U.S.C. §112(f), only if the terms “means for” or “step for” are explicitly recited in the respective limitation.

What is claimed is

1. A system comprising an internal combustion engine having a plurality of piston-cylinders that cause rotation of a crankshaft; a crankshaft sensor configured to sense rotational speed of the crankshaft; and a controller having a processor and a memory, wherein the controller is configured to calculate an acceleration of each piston-cylinder based upon the rotational speed of the crankshaft and then balance the accelerations of the respective piston-cylinders by modifying a combustion input to one or more of the piston-cylinders.

2. The system according to claim 1, wherein the controller is further configured to calculate the acceleration of each piston-cylinder during each of a plurality of combustion cycles, each combustion cycle having one combustion event per piston-cylinder.

3. The system according to claim 2, wherein the controller is further configured to
calculate angular acceleration of the crankshaft by differentiating the rotational speed of the crankshaft,
identify a portion of the angular acceleration of the crankshaft that is caused by each respective piston-cylinder, and then
quantify the acceleration of each piston-cylinder based upon the angular acceleration of the crankshaft that is caused by each piston-cylinder.

4. The system according to claim 3, wherein the control circuit is further configured to quantify the acceleration of each piston-cylinder by calculating a root mean square of the portion of the angular acceleration of the crankshaft that is caused by each piston-cylinder.

5. The system according to claim 3, wherein the controller comprises a low pass filter and wherein the controller is configured to filter the angular acceleration of the crankshaft to thereby remove artifacts that are not derived from combustion.

6. The system according to claim 2, wherein the controller is configured to store the acceleration of each piston-cylinder during each of the combustion cycles in a buffer and thereafter to perform as statistical analysis on the buffer to identify any accelerations of the piston-cylinders that are out of balance.

7. The system according to claim 6, wherein the controller is configured to compare a result of the statistical analysis to a stored threshold to thereby identify the accelerations of the piston-cylinders that are out of balance.

8. The system according to claim 1, wherein the combustion input comprises ignition and wherein the controller is configured to modify the combustion input by modifying a timing of the ignition.

9. The system according to claim 1, further comprising a camshaft connected to the piston-cylinders via the crankshaft, and further comprising a camshaft sensor configured to sense rotational speed of the camshaft, and further comprising a firing order of the piston-cylinders that is stored in the memory of the controller, and wherein the controller is configured to identify a piston-cylinder that is out of balance based upon inputs from the camshaft sensor, the crankshaft sensor, and the firing order.

10. The system according to claim 1, wherein the controller is configured to assign each piston-cylinder a gated window during a power stroke of the respective piston-cylinder, wherein the controller is further configured to store the accelerations of the piston-cylinders based upon the gated window in which the respective piston-cylinder produces an acceleration, and wherein the controller is further configured to modify the combustion input based upon the accelerations.

11. The system according to claim 1, wherein the control circuit is configured to repeatedly calculate an acceleration of each piston-cylinder based upon the rotational speed of the crankshaft and thereafter balance the accelerations of the respective piston-cylinders by modifying a combustion input to one or more of the piston-cylinders.

12. A method of controlling an internal combustion engine having a plurality of piston-cylinders that cause rotation of a crankshaft, the method comprising sensing rotational speed of the crankshaft, calculating an acceleration of each piston-cylinder based upon the rotational speed of the crankshaft, and then balancing the accelerations of the respective piston-cylinders by modifying a combustion input to one or more of the piston-cylinders.

13. The method according to claim 12, further comprising calculating the acceleration of each piston-cylinder during each of a plurality of combustion cycles, each combustion cycle having one combustion event per piston-cylinder.

14. The method according to claim 13, further comprising
calculating angular acceleration of the crankshaft by differentiating, the rotational speed of the crankshaft,
identifying a portion of the acceleration of the crankshaft that is caused by each respective piston-cylinder, and then
quantifying the acceleration of each piston-cylinder based upon the angular acceleration of the crankshaft that is caused by each piston-cylinder.

15. The method according to claim 14, further comprising quantifying the acceleration of each piston-cylinder by calculating a root mean square of the portion of the angular acceleration of the crankshaft that is caused by each piston-cylinder.

16. The method according to claim 14, further comprising filtering the angular acceleration of the crankshaft to thereby remove artifacts that are not derived from combustion.

17. The method according to claim 14, further comprising, storing the output force provided by each piston-cylinder during each of the combustion cycles in a buffer and thereafter performing a statistical analysis on the buffer to identify any accelerations of the piston-cylinders that are out of balance.

18. The method according to claim 17, further comprising comparing the result of the statistical analysis to a threshold to identify the accelerations of the piston-cylinders that are out of balance.

19. The method according to claim 12, further comprising modifying the combustion input by modifying a timing of ignition for the combustion event.

20. The method according to claim 12, further comprising sensing rotational speed of a camshaft connected to the piston-cylinders via the crankshaft and identifying, a piston-cylinder that is out of balance used upon the rotational speed of the camshaft, the rotation speed of the crankshaft and a firing order of the piston-cylinders.

21. The method according to claim 12, comprising, repeatedly calculating an acceleration of each piston-cylinder based upon the rotational speed of the crankshaft and thereafter balancing the accelerations of the respective piston-cylinders by modifying a combustion input to one or more of the piston-cylinders.

22. The method according to claim 12, further comprising assigning each piston-cylinder a gated window during a power stroke of the respective piston-cylinder, storing the accelerations of the piston-cylinder based upon the gated window in which the respective piston-cylinder produces an acceleration, and further modifying the combustion input based upon the accelerations.
